(19) United States
(12) Patent Application Publication
(10) Pub. No.: US 2004/0036792 A1
(43) Pub. Date: Feb. 26, 2004

(54) Camera system and focus information display apparatus

(76) Inventors: Chikatsu Moriya, Saitama-shi (JP); Tadashi Sasaki, Saitama-shi (JP)

Correspondence Address: HARNESS, DICKEY & PIERCE, P.L.C., P.O. BOX 8910, RESTON, VA, 20195, US

(21) Appl. No.: 10/642,140

(22) Filed: Aug. 18, 2003

(30) Foreign Application Priority Data
Aug. 23, 2002 (JP) 2002-243356
Sep. 30, 2002 (JP) 2002-284936
Apr. 2, 2003 (JP) 2003-098888

(51) Int. Cl. H04N 5/232

(52) U.S. Cl. 348/345

(57) ABSTRACT

A focus evaluation value used for contrast-determination autofocus (AF) and a focus position at the time of determination of the focus evaluation value are enabled to be outputted to a peripheral device such as a personal computer. This enables an operator to readily obtain information on the focus evaluation value from the peripheral device in a case such as an AF malfunction and thereby referring to the information to elucidate the cause of the AF malfunction. Furthermore, for determination of correct focusing in a tracking adjustment of a shooting lens, the relative magnitude of the focus signal continuously obtained according to video signals of a camera is displayed as a graph on a monitor, and the size of the graph is changed according to a maximum focus signal value obtained. Therefore, the graph can be displayed in an appropriate size on the monitor irrespective of variances of the magnitude of the focus signal due to different objects of shooting. This enables determination of correct focusing and a focus adjustment with accuracy and ease.

### BACKGROUND OF THE INVENTION

1. Field of the Invention

The present invention relates to a camera system and a focus information display apparatus. More particularly, the invention relates to a camera system with a contrast-determination autofocus capability and a focus signal display apparatus that displays a focus signal for determining correct focusing in a tracking adjustment of a shooting lens.

2. Description of the Related Art

In autofocus (AF) used in broadcast television cameras, malfunctions should be minimized. Generally, television cameras adopt contrast-determination AF. For example, the contrast-determination AF extracts high-frequency components from a video signal that forms an image shot (video image), and according to the high-frequency components, generates a focus evaluation value that indicates the degree of contrast of the image shot. The focus evaluation value is a value for evaluating a focus state (the degree of focusing). The focus of a shooting lens is automatically adjusted to maximize the focus evaluation value, so that an object of shooting comes into focus.

A shooting lens used in television cameras generally has a movable lens group (referred to as a tracking lens hereafter) arranged as part of its relay system. The position of the tracking lens is factory-adjusted for a tracking adjustment (flange back adjustment) (see U.S. Pat. No. 6,501,505, for example).

A tracking adjustment is a focus adjustment by which the position of the imaging plane (focus position) of the shooting lens is adjusted with the tracking lens to avoid an out-of-focus state mainly due to zooming (a zoom focus shift). For example, this may be done in the following steps. First, with the tracking lens being fixed, a focus lens of the shooting lens is set at the infinity for a target still object located as far as possible. Then, the zoom is set at the wide end, and the position of the tracking lens is adjusted for correct focusing. The zoom is then set at the tele end, and the position of the focus lens is adjusted for correct focusing. In this way, while repeatedly switching the zoom position between the wide and tele ends, the position of the tracking lens is adjusted at the wide end and the position of the focus lens is adjusted at the tele end for correct focusing. When the zooming no more causes an out-of-focus state, the tracking adjustment is completed.

In this tracking adjustment operation, accurate determination of correct focusing is important. However, determination from a video on a monitor does not provide enough accuracy. A method that has been used is to monitor a focus signal obtained from video signals of the camera on a monitor such as an oscilloscope and to determine that correct focusing is achieved when the focus signal value (focus evaluation value) is at the maximum.

A possible display mode for displaying the focus signal on the monitor is a graph with a two-dimensional coordinates plane rendered on a monitor screen, on which the horizontal axis indicates time and the vertical axis indicates the focus signal value, i.e., focus evaluation value. The focus evaluation value is periodically sampled and plotted on the coordinates plane. For example, if the tracking lens is moved, the plot position on the coordinates plane fluctuates accordingly with time (relative to the horizontal axis). The horizontal axis may alternatively indicate the position of the tracking lens, as will be described in a detailed description of preferred embodiments of the present invention. In this way, correct focusing can be achieved accurately by referring to the focus signal displayed as a graph and adjusting the position of the tracking lens so that the focus evaluation value takes the peak value.

Besides the above-described tracking adjustment, a normal focus adjustment (especially a manual focus adjustment) may also advantageously refer to the focus signal in determination of correct focusing.

However, some shooting conditions and object conditions may not be successfully addressed by AF systems. Specifically, the contrast-determination AF generally tends to fail to determine an in-focus state for a low-contrast video that has less high-frequency components in its video signal. Other causes of AF malfunctions include phenomena called moire and spurious resolution in which the focus evaluation value takes the peak value even in an out-of-focus state.

If an AF malfunction has occurred such as at a rehearsal, the cause of the malfunction should be found to take measures against it before an actual shooting. For this purpose, it will be very convenient to be able to check for changes in the focus evaluation value due to focusing and so on. At a manufacturing stage, for example, the focus evaluation value may be displayed on a monitor by capturing data of an AF-controlling CPU through a tool such as a program development tool. However, in an operation away from such a development tool, an operator cannot know the focus evaluation value processed within the CPU. Even at the manufacturing stage, using the program development tool to display the focus evaluation value is problematic in that it requires some effort.

Moreover, the magnitude of the focus signal, especially the peak value (maximum value) depends on each object. The focus signal value is larger for a higher-contrast object being shot, whereas it is smaller for a lower-contrast object being shot.

Therefore, when the focus signal is displayed as a graph such as the one described above, a low-contrast object results in a low peak value of the focus signal. This makes it difficult to find the peak of the focus signal according to the graph. This problem could be addressed by limiting the range of the coordinate axis (vertical axis) to scale up the graph. That is, the range of the focus signal value that corresponds to the range of the scale of the coordinate axis (vertical axis) (coordinate values that corresponds to the screen) between the minimum and maximum values could be reduced. However, the focus signal value of a high-contrast object would then exceed the maximum value of this scale around its peak, which poses a problem that the peak of the focus signal cannot be found.

Furthermore, determining how large the focus signal value will be from the object to be shot is difficult even for a skilled person. Therefore, an appropriate prior adjustment of the range of the coordinate axis is difficult.

### SUMMARY OF THE INVENTION

The present invention has been made in view of these circumstances. Thus, an object of the present invention is to provide a camera system that enables an operator to readily obtain information on the focus evaluation value for use in AF as reference data such as for elucidating the cause of an AF malfunction.

Another object of the present invention is to provide a focus information display apparatus by which determination of correct focusing and a focus adjustment can be performed with accuracy and ease according to the focus information displayed on a monitor or the like.

In order to attain the above objects, the present invention is directed to a camera system, comprising: a focus evaluation value determination device which determines a focus evaluation value corresponding to a contrast of an object image shot by a shooting lens; an autofocus device which automatically adjusts a focus of the shooting lens for an in-focus state according to the focus evaluation value determined by the focus evaluation value determination device; and an output device which outputs, to a peripheral device, the focus evaluation value determined by the focus evaluation value determination device and a focus position of the shooting lens at the time of determination of the focus evaluation value.

Preferably, the output device transmits the focus evaluation value and the focus position by serial communication to the peripheral device connected to allow serial communication.

Preferably, the peripheral device obtains the focus evaluation value and the focus position outputted from the output device and comprises a display device for displaying a relationship between the focus evaluation value and the focus position as a graph.

For example, the peripheral device is a personal computer.

According to the present invention, the focus evaluation value used for autofocus (AF) and the focus position at the time of determination of the focus evaluation value can be outputted to a peripheral device. This enables an operator to readily obtain information on the focus evaluation value from the peripheral device in a case such as an AF malfunction and thereby referring to the information to elucidate the cause of the AF malfunction.

The present invention is also directed to a focus information display apparatus which generates a focus signal representing a degree of focusing according to a high-frequency component of an image formed by a shooting lens and displays focus information on a display screen according to the generated focus signal, the apparatus comprising: a focus signal obtaining device which continuously obtains the focus signal while a focus position of the shooting lens is changed; a maximum value determination device which determines a maximum value of the focus signal obtained by the focus signal obtaining device; a display device which displays a relative magnitude of the focus signal obtained by the focus signal obtaining device as a magnitude recognizable with at least one of a graph and a number on the display screen; and a changing device which changes a size of the displayed at least one of graph and number according to a value of the focus signal obtained by the focus signal obtaining device so that the size of the displayed at least one of graph and number on the display screen that corresponds to the maximum value determined by the maximum value determination device becomes a predetermined size irrespective of how large the maximum value is.

Preferably, the display device displays a graph on which coordinate values of a coordinate axis on the display screen correspond to values of the focus signal obtained by the focus signal obtaining device; and the changing device changes a range of the values of the focus signal that corresponds to a range of the coordinate axis from a minimum coordinate value to a maximum coordinate value into a range of the focus signal from a minimum value to the maximum value obtained by the maximum value determination device.

Preferably, the maximum value determination device determines the maximum value of the focus signal each time the focus signal is obtained by the focus signal obtaining device.

Preferably, the focus information display apparatus further comprises: a reset instruction device which instructs a reset, wherein once a reset is instructed by the reset instruction device, the maximum value determination device determines the maximum value among values of the focus signal obtained by the focus signal obtaining device after the instruction.

Preferably, the focus information display apparatus further comprises an in-focus indication device which indicates whether a current focus position of the shooting lens is an in-focus position according to the focus signal obtained by the focus signal obtaining device.

According to the present invention, the relative magnitude of the focus signal continuously obtained is displayed as a magnitude recognizable with a graph or number on a display screen. The size of the graph or number is changed according to the focus signal value so that the size of the graph or number that corresponds to the maximum focus signal value obtained becomes a predetermined size. Therefore, the magnitude of the focus signal can be displayed on the display screen with an appropriate size of graph or number irrespective of variances of the magnitude of the focus signal due to different objects of shooting. This enables determination of correct focusing and a focus adjustment with accuracy and ease. Furthermore, since the maximum focus signal value obtained can be reset, the magnitude of the focus signal can be displayed with an appropriate size of graph or number by a reset instruction even if the condition of an object has changed. In addition, an in-focus indicator is provided for indicating whether the focus position of a shooting lens is an in-focus position, which also enables determination of correct focusing and a focus adjustment with accuracy and ease.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a perspective view showing an embodiment of a television camera system in which a lens system according to an embodiment of the present invention is used;

FIG. 2 is a block diagram showing an overall configuration of the lens system;

FIG. 3 illustrates a relationship between focus evaluation values and focus positions displayed as a graph;

FIG. 4 illustrates a relationship between focus evaluation values and focus positions displayed as a graph in the case of spurious resolution;

FIG. 5 is a block diagram showing a configuration of a television camera system to which an embodiment of the present invention is applied;

FIG. 6 shows a focus information display mode in a first embodiment displayed on a monitor of a personal computer;

FIG. 7 shows the focus information display mode in the first embodiment displayed on the monitor of the personal computer;

FIG. 8 shows the focus information display mode in the first embodiment displayed on the monitor of the personal computer;

FIG. 9 is a flowchart showing processing steps in a CPU of the personal computer in the first embodiment;

FIG. 10 shows a focus information display mode in a second embodiment displayed on the monitor of the personal computer;

FIG. 11 shows the focus information display mode in the second embodiment displayed on the monitor of the personal computer;

FIG. 12 shows the focus information display mode in the second embodiment displayed on the monitor of the personal computer;

FIG. 13 shows a focus information display mode in a third embodiment displayed on the monitor of the personal computer;

FIG. 14 shows the focus information display mode in the third embodiment displayed on the monitor of the personal computer;

FIG. 15 is a flowchart showing processing steps in the CPU of the personal computer in the third embodiment;

FIG. 16 shows the television camera system of FIG. 5 provided with a reset function for focus information display;

FIG. 17 shows a monitor screen with a reset switch displayed on it;

FIG. 18 shows a camera viewfinder with a reset switch placed at a frame portion of it;

FIG. 19 shows a flowchart showing processing steps in the CPU of the personal computer where processing of the reset function is enabled in the first embodiment;

FIG. 20 shows a flowchart showing processing steps in the CPU of the personal computer where processing of the reset function is enabled in the third embodiment;

FIG. 21 shows the monitor of the personal computer with a best focus indication mark displayed on it;

FIG. 22 shows the camera viewfinder with the best focus indication mark displayed on it;

FIG. 23 is a flowchart showing processing steps in the CPU of the personal computer where processing of a best focus indication function is enabled in the third embodiment; and

FIG. 24 is a flowchart showing processing steps in the CPU of the personal computer where processing of the best focus indication function is enabled in the third embodiment.

### DETAILED DESCRIPTION OF THE PREFERRED EMBODIMENTS

With reference to the appended drawings, preferred embodiments of a camera system and a focus information display apparatus according to the present invention will be described in detail below.

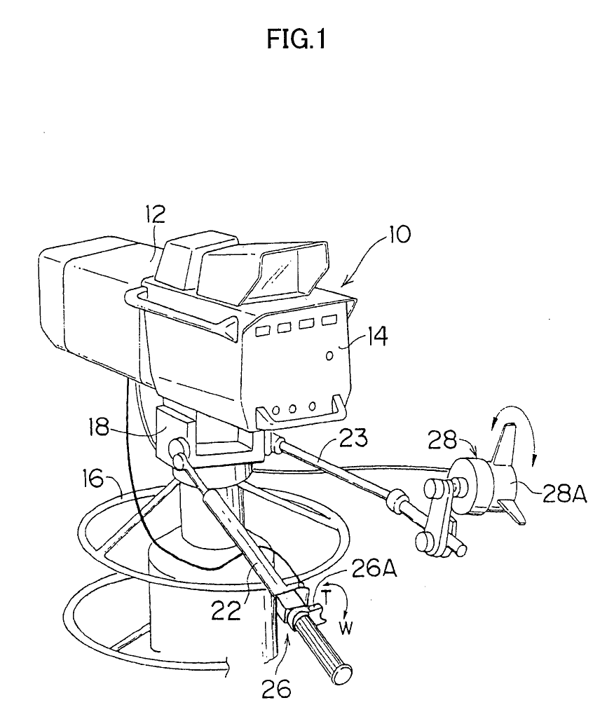

FIG. 1 is a perspective view showing an embodiment of a television camera system to which the present invention is applied. As shown, the television camera 10 comprises a lens device 12 and a camera body 14, and it is supported by a pan head 18 on a pedestal dolly 16. The pan head 18 has two operation rods 22 and 23 extended from it. The ends of the operation rods 22 and 23 are provided with a zoom demand 26 and a focus demand 28, respectively, which are connected to the lens device 12 by cables.

The zoom demand 26 has a thumb ring 26A, which is rotatable in either direction from a reference position. When the thumb ring 26A is rotated, a zoom command signal relative to the amount of operation (direction and amount of rotation) from the reference position is provided from the zoom demand 26 to the lens device 12. This allows the zoom of a shooting optical system (shooting lens) of the lens device 12 to be shifted to the wide side or the tele side.

The focus demand 28 has a rotatable focus ring 28A. When the focus ring 28A is rotated, a focus command signal relative to the amount of operation (direction and amount of rotation) is provided from the focus demand 28 to the lens device 12. This allows the focus of the shooting lens of the lens device 12 to be shifted to the close focus side or the infinity side.

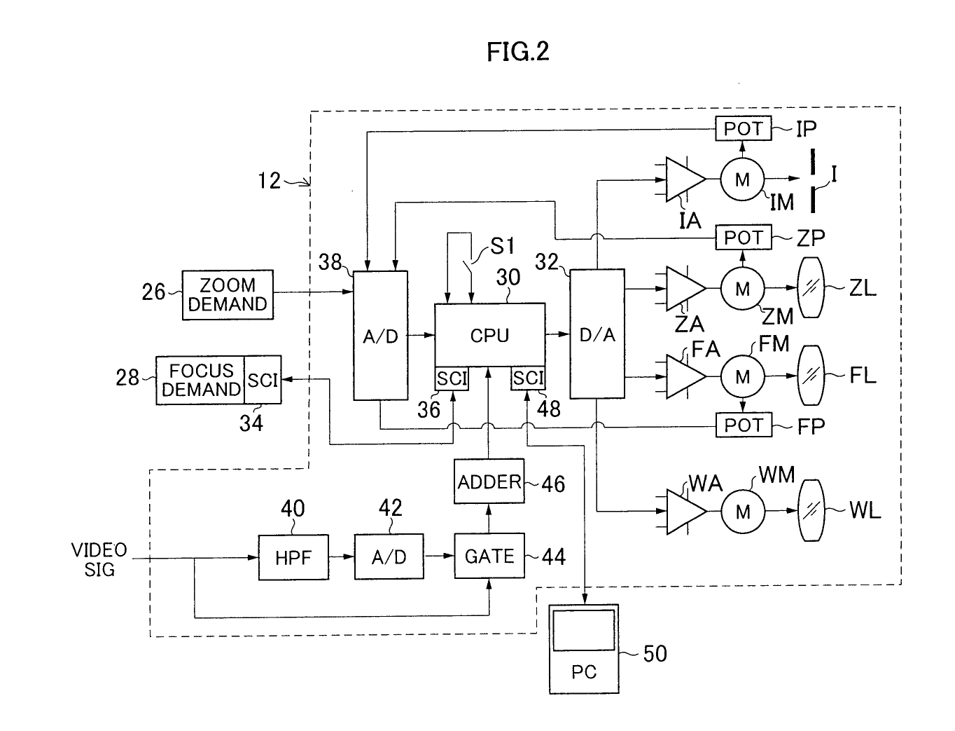

FIG. 2 is a block diagram showing an overall configuration of a lens system to which the present invention is applied. In the lens system shown in FIG. 2, the shooting optical system (shooting lens) of the lens device 12 includes, for example, a focus lens (group) FL, a zoom lens (group) ZL, an iris I, and a wobbling lens (group) WL, all of which are well known. An object ray that is incident on the shooting lens forms an image on an imaging elements surface of the camera body 14.

The lenses FL, ZL, WL and the iris I are driven by a focusing motor FM, a zooming motor ZM, a wobbling motor WM, and an iris motor IM, respectively (each lens is moved along the optical axis and the iris has its aperture amount changed). The motors FM, ZM, WM, and IM are driven by a focusing amplifier FA, a zooming amplifier ZA, a wobbling amplifier WA, and an iris amplifier IA, respectively, according to drive signals provided by a CPU 30 in the lens device 12 via a D/A converter 32.

The focus demand 28 and the CPU 30 can exchange various signals through communication via serial communication interfaces (SCI) 34 and 36. For example, as will be described in detail later, the focus demand 28 provides a focus command signal to the CPU 30 according to the rotation operation of the focus ring 28A.

In a manual focus (MF) mode, the CPU 30 performs MF processing according to the focus command signal provided by the focus demand 28. That is, according to the focus command signal provided by the focus demand 28 and on a position signal that indicates the current position of the focus lens FL provided by a focusing potentiometer FP via an A/D converter 38, the CPU 30 provides the drive signal for driving the focusing motor FM as described above. The drive signal is provided to the focusing amplifier FA via the D/A converter 32, thereby moving the focus lens FL to a target position that is set according to the focus command signal.

The zoom demand 26 also provides a zoom command signal to the CPU 30 via the A/D converter 38, which specifies a moving speed (target speed) of the zoom lens ZL relative to the rotation amount of the thumb ring 26A. As with the focus demand 28, the zoom demand 26 and the CPU 30 may be configured to be able to exchange various signals through communication. According to the zoom command signal provided by the zoom demand 26 and on a position signal that indicates the current position of the zoom lens ZL provided by a zooming potentiometer ZP via the A/D converter 38, the CPU 30 provides the drive signal for driving the zooming motor ZM as described above. The drive signal is provided to the zooming amplifier ZA via the D/A converter 32, thereby moving the zoom lens ZL at the target speed specified by the zoom command signal.

For the iris I, an iris command signal that specifies a position at which the iris I is set (aperture value) is generally provided by the camera body 14 to the CPU 30. As described above, while using an iris potentiometer IP to determine a rotation position of the iris motor IM where the iris I is to be set, the CPU 30 outputs the drive signal for driving the iris motor IM to the iris amplifier IA so that the aperture value specified by the command signal is achieved.

For the wobbling lens WL, its drive signal is not outputted according to an external command signal. Rather, the drive signal for wobbling in autofocus, which will be described later, is outputted by the CPU 30 to the wobbling amplifier WA. The wobbling motor WM may be a pulse motor, for example, with no potentiometer for feeding back the position of the wobbling lens WL.

In this lens system, the lens device 12 may have an AF switch S1, for example, which enables switching between the autofocus (AF) mode and the manual focus (MF) mode. In the MF mode, the focus lens FL is driven by the motor as described above according to MF processing (described in detail later) performed according to the focus command signal from the focus demand 28.

On the other hand, in the AF mode, the focus lens FL is driven by the motor according to AF processing performed according to information on an object of shooting, and the focus lens FL is automatically set at a focus position.

The AF mode in this embodiment is a continuous AF mode in which the AF processing is continuously performed. However, it may be what is called a one-shot AF mode in which the AF processing is completed in one focusing.

The lens device 12 of the lens system includes a focus evaluation value determination circuit, to which the camera body 14 inputs a video signal (luminance signal) for video display. According to the video signal, a focus evaluation value that evaluates the degree of focusing is determined. The video signal that is inputted from the camera body 14 may be an NTSC video signal, for example, and is obtained by shooting, with the imaging elements of the camera body 14, an object image formed by the shooting optical system. The focus evaluation value indicates the degree of contrast (sharpness) of the image, and how to determine this value is well known in the field of contrast-determination AF.

In the focus evaluation value determination circuit shown in FIG. 2, the video signal received from the camera body 14 is first processed by a high-pass filter (HPF) 40, which extracts only high-frequency components from the video signal. The high-frequency components are converted into digital signals by an A/D converter 42. Then, from the high-frequency components converted into the digital signals, a gate circuit 44 extracts only those signals that are within a predetermined focus area defined in a shooting range. Besides the signals from the A/D converter 42, the gate circuit 44 also directly receives input of the video signal and uses synchronization signals in the video signal for extracting the signals within the focus area. The high-frequency signals extracted by the gate circuit 44 are added up for each field by an adder 46. A resulting signal is read by the CPU 30 as the focus evaluation value that indicates the degree of focusing (degree of contrast) for the object in the focus area. It is noted that determination of the focus evaluation value from the video signals is not limited to this manner.

In the AF processing in the AF mode, the CPU 30 generates the drive signal for driving the focusing motor FM according to the focus evaluation value. As in the case of MF, the drive signal is outputted to the focusing amplifier FA to move the focus lens FL to an in-focus position. Specifically, the CPU 30 outputs the drive signal for driving the wobbling motor WM to the wobbling amplifier WA via the D/A converter 32 as appropriate and moves back and forth (wobbles) the wobbling lens WL along the optical axis. While doing so, the CPU 30 obtains the focus evaluation value (e.g., for each field) from the focus evaluation value determination circuit (adder 46). Thus, the focus position of the shooting optical system is shift back and forth, and the focus evaluation value is determined that corresponds to the focus lens FL moved back and forth from the current position. The CPU 30 determines whether the focus evaluation value is at the maximum or not at the current position of the focus lens FL according to the focus evaluation value obtained during the wobbling. The focus evaluation value that reaches the maximum indicates that correct focusing has been achieved, so that the focus lens FL is stopped at that in-focus position. On the other hand, if the focus evaluation value is not at the maximum, it is determined whether the in-focus position is on the infinity side or the close focus side relative to the current position, according to the relative magnitude of the focus evaluation values obtained during the wobbling. That is, the direction in which the focus evaluation value increases is determined. Then, the drive signal is outputted to the focusing amplifier FA to move the focus lens FL in the direction determined. In this way, repeating the wobbling of the wobbling lens WL and the moving of the focus lens FL allows the focus lens FL to be automatically set to the in-focus position.

In this lens system, a desired peripheral device can be connected to a certain connector of the lens device 12 by a cable so that various signals can be exchanged between the CPU 30 of the lens device 12 and the peripheral device through communication via a serial communication interface (SCI) 48. FIG. 2 shows a personal computer 50 being connected as a peripheral device.

By connecting a peripheral device such as the personal computer 50 to the lens device 12, the CPU 30 is enabled to transmit information to the personal computer 50 in the AF mode. For example, the CPU 30 can transmit the focus evaluation value continuously received from the focus evaluation value determination circuit (adder 46), and the position of the focus lens FL (focus position) received from the focusing potentiometer FP at the time of reception of the focus evaluation value. These information items may be temporarily stored in predetermined memory in the lens device 12 before all transmitted to the personal computer 50 at a certain time. Alternatively, on each reception of the focus evaluation value, it may be transmitted to the personal computer 50 along with the focus position information.

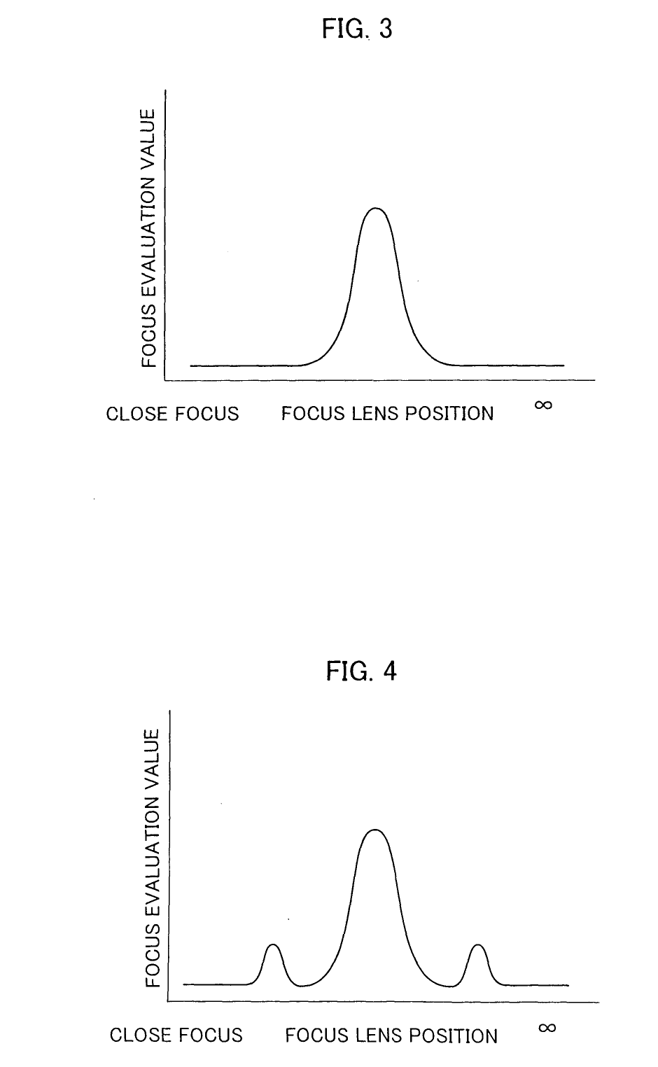

On the personal computer 50, a predetermined program is activated to receive the information on the focus evaluation value and the focus position transmitted by the lens device 12 and to display the relationship between them as a graph on a monitor. For example, the relationship between the focus evaluation value and the focus position transmitted by the lens device 12 is displayed as a graph as shown in FIG. 3, on which the horizontal axis indicates the focus position (focus lens position) and the vertical axis indicates the focus evaluation value.

In some cases, the moving range of the focus lens FL in the AF operation may not provide the focus evaluation value for the whole range of focus position from the close focus end to the infinity end. In such a case, an operator may turn on a predetermined switch to cause the focus lens FL to move to the close focus end under the control of the CPU 30 of the lens device 12. The focus lens FL is then moved to the infinity end at a predetermined speed. During the movement, in the same manner as in AF, the CPU 30 receives the focus evaluation value and the focus position from the focus evaluation value determination circuit and the focusing potentiometer FP respectively and transmits them to the personal computer 50. Thus, the personal computer 50 displays a graph of the focus evaluation value for the whole range of focus position on the monitor, so that it can be seen how the focus evaluation value changes over the whole range of focus position. The predetermined switch may be provided on any part including the lens device 12 and the focus demand 28.

FIG. 4 shows an exemplary graph displayed on the monitor of the personal computer 50 when an AF malfunction has occurred. From a graph like this, it can be seen that spurious resolution appeared and caused the AF malfunction.

The graph of the relationship between the focus evaluation value and the focus position as described above may be displayed not only in the AF mode but also in the MF mode in the same manner.

In the above embodiment, the peripheral device such as the personal computer 50 is connected to the lens device 12, and the CPU 30 of the lens device 12 outputs the focus evaluation value and the focus position to the peripheral device. However, the peripheral device may also be connected to the camera body 14 or to an operating device such as the focus demand 28 to allow them to transmit the focus evaluation value and the focus position to the peripheral device. In addition, the focus evaluation value may not necessarily be processed in the lens device 12, but may be processed in the camera body 14 or an operating device. In that case, the processing part preferably has a connector for connecting the peripheral device to it. The peripheral device may preferably be connected to any part convenient for providing a connector or transmitting information such as the focus evaluation value.

Although the above embodiment uses serial communication (digital communication) to output information such as the focus evaluation value to the peripheral device, the embodiment is not limited to it but may use analog signals for outputting to the peripheral device. However, since the focus evaluation value has a very wide dynamic range (e.g., 1:100,000 or more), serial communication is more effective.

The above embodiment uses a personal computer as the peripheral device. However, it is not limited to a personal computer but may be a special-purpose device for displaying information such as the focus evaluation value, or other general-purpose devices.

Thus, the above embodiment has been described for the contrast-determination system in which AF is performed by determining the focus evaluation value according to the video signal obtained by the imaging elements of the camera body, and by setting the position of the focus lens FL so that the focus evaluation value is at the maximum. However, the present invention may also be applied to the cases that adopt a contrast-determination system described below or systems other than the contrast-determination systems.

For example, the above embodiment determines whether the focus evaluation value is at the maximum or not at the current position of the focus lens FL by wobbling the wobbling lens WL. However, the present invention may also be applied to a contrast-determination system that does not perform wobbling but uses imaging elements arranged at different positions with different optical paths (all imaging elements may be dedicated to AF, or an imaging element for generating video signals for video display may also be used as one of the imaging elements for AF). In that system, according to a plurality of video signals obtained by the imaging elements with different optical paths, the focus evaluation value is determined for each video signal as in the above embodiment. Then, from the relative magnitude of the focus evaluation value, it is determined whether correct focusing is being achieved at the current position of the focus lens FL, and if it is not being achieved, whether the in-focus position is on the infinity side or the close focus side relative to the current position of the focus lens FL.

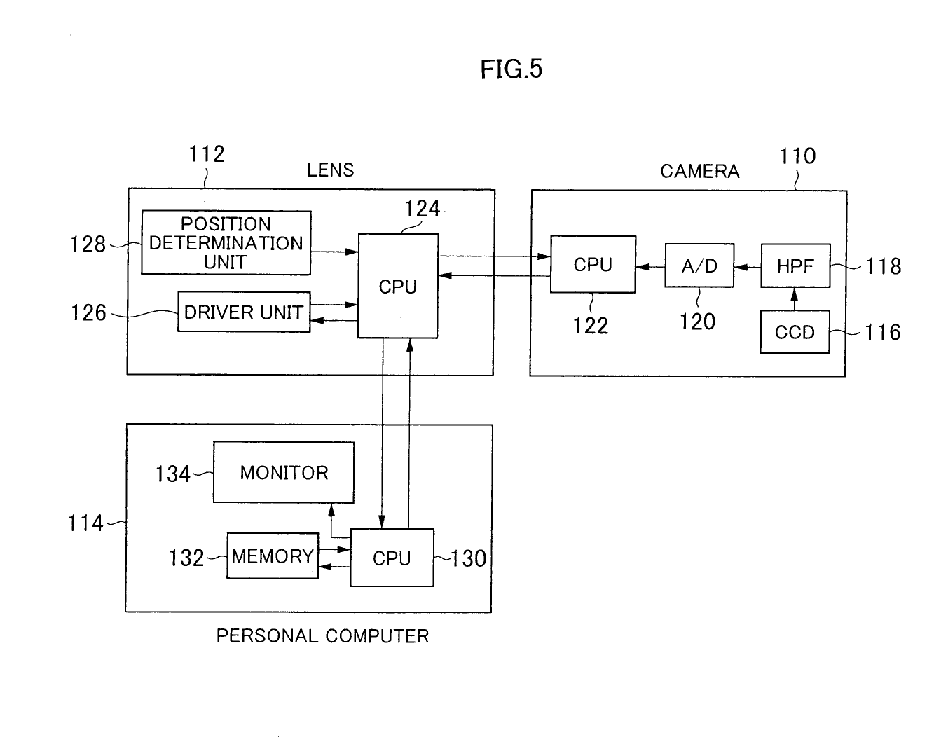

Now, embodiments of the focus evaluation value display apparatus will be described. FIG. 5 is a block diagram showing a configuration of a television camera system to which the present invention is applied. As shown, the system comprises a camera 110, a lens 112 (lens device), and a personal computer 114. Although the camera 110 and the lens 112 essentially include various optical parts and processing circuits for shooting an object, only those relevant to the focus information display are shown.

The camera 110 includes a CCD 116 (and its processing circuit) that photoelectrically converts an image formed by the optical system of the lens 112 and outputs it as a video signal such as an interlaced video signal. The video signal (e.g., luminance signal) from the CCD 116 are used for video output and are also inputted to a high-pass filter 118 to be used for generating a focus evaluation value. The high-pass filter 118 extracts only high-frequency components from the inputted video signal. The signals of the high-frequency components are then converted into digital signals by an A/D converter 120 and sampled in a predetermined cycle by a CPU 122. The CPU 122 adds up the sampled signals of the high-frequency components for each field, for example, thereby generating data of a focus signal. The focus signal represents a signal of a focus evaluation value that numerically represents and evaluates the degree of contrast of the image.

The lens 112 has a CPU 124 as a component of its control system. The CPU 124 is communicatively connected to the CPU 122 of the camera 110 so that they can exchange various signals. This enables the focus signal data generated by the CPU 122 of the camera 110 to be transmitted to the CPU 124 of the lens 112. The CPU 124 of the lens 112 is also communicatively connected to a CPU 130 of a personal computer 114 so that they can exchange various signals. This enables the focus signal data received by the CPU 124 of the lens 112 to be transmitted to the CPU 130 of the personal computer 114.

The lens 112 has an optical system and a control system. The optical system includes, for example, a focus lens movable along the optical axis continuously from the front stage side, a zoom lens, an iris that opens and closes, a relay lens (master lens), and so on. A tracking lens movable along the optical axis for a tracking adjustment is placed as part of the relay lens. The control system includes drive units for driving the focus lens, zoom lens, iris, and tracking lens by motors, as well as position determination units for determining their current positions. FIG. 5 shows a drive unit 126 for driving the tracking lens by a motor, and a position determination unit 128 for determining the current position of the tracking lens. The position signal that is outputted from the position determination unit 128 is read by the CPU 124, which transmits it as position signal data that indicates the current position of the tracking lens to the personal computer 114 along with the focus signal data. The focus signal data and the position signal data are transmitted to the personal computer 114 periodically, or at predetermined moving distances of the tracking lens.

Furthermore, by operating a device such as a keyboard (not shown) of the personal computer 114, a command signal according to the operation is transmitted from the personal computer 114 to the drive unit 126 via the CPU 124 of the lens 112. The drive unit 126 then drives the tracking lens with the motor. Thus, an operator can operate the personal computer 114 to adjust the position of the tracking lens for a focus adjustment of the optical system. However, the tracking lens may be driven with a predetermined operating tab on the lens housing, or with a controller connected to the lens 112 other than the personal computer 114. The tracking lens may also be driven only manually, in which case the drive unit 126 shown is not provided. It is to be understood that description of operation and processing to drive the tracking lens will be omitted for the present embodiment.

The personal computer 114 may be a commercially available one, and among its components only the CPU 130, memory 132, and a monitor 134 are shown for simplicity. When a predetermined software program for a tracking adjustment is activated, the CPU 130 executes processing according to the software program. Thus, the CPU 130 reads the focus signal data and the position signal data of the tracking lens from the CPU 124 of the lens 112, and according to the data, the focus information is displayed on the monitor 134.

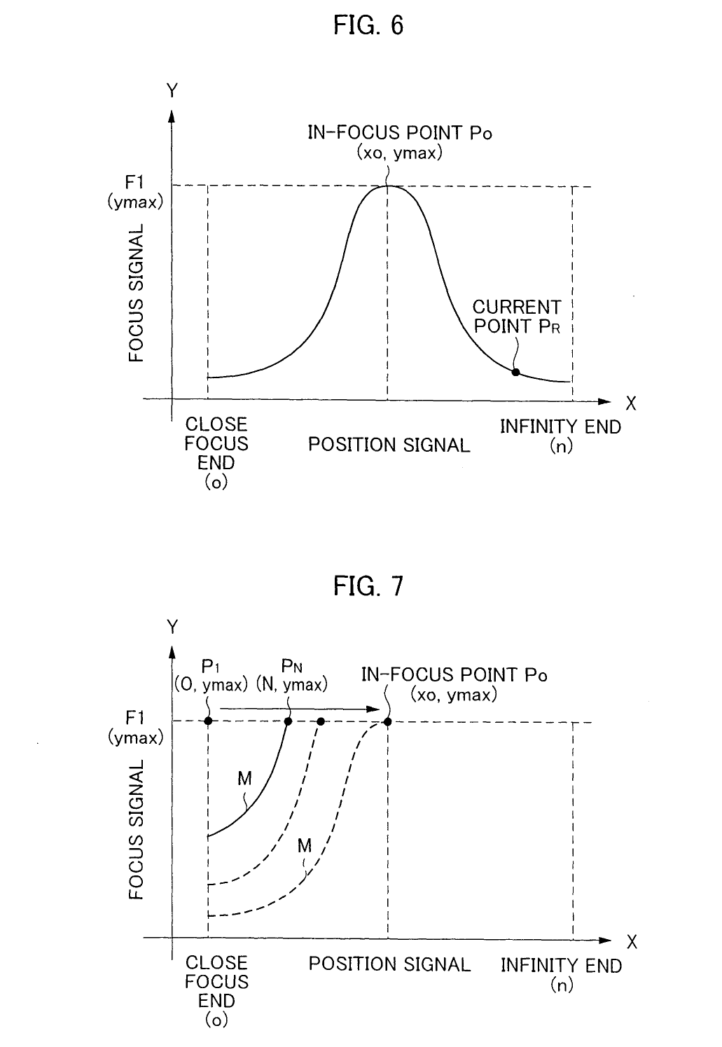

FIG. 6 illustrates a screen of the focus information displayed on the monitor 134 of the personal computer 114. As shown, the screen of the monitor 134 displays a two-dimensional graph of the focus information, on which the horizontal axis (X-axis) indicates the position signal value of the tracking lens and the vertical axis (Y-axis) indicates the focus signal value. For example, the tracking lens is moved from the close focus end to the infinity end in a tracking adjustment. During the movement, a coordinates point (x, y) is plotted periodically (or at predetermined moving distances of the tracking lens) on the coordinates plane in real time as a point that depicts a graph in a color different from the background color. The coordinates point corresponds to the position signal value for the position where the tracking lens is currently passing through, and the focus signal value at that time. This results in the graph displayed as shown in FIG. 6 with its peak (maximum Y coordinate value) at a coordinates point P₀ (x₀, y₀=yₘₐₓ) where correct focusing is achieved. The coordinates point P₀ (x₀, yₘₐₓ) where the graph has its peak will be referred to as an in-focus point hereafter. It is noted that the coordinates point (x, y) does not indicate the values of the position signal and the focus signal. Rather, it is a point of an X coordinate value x and a Y coordinate value y fixed with respect to the display position on the screen of the monitor 134. In particular, the X coordinate value x takes a minimum value 0 at the close focus end and a maximum integer value n at the infinity end, and the value is incremented or decremented by one at every predetermined moving distance of the tracking lens.

The coordinates point that corresponds to the current position of the tracking lens (current point P_{R}) is plotted as a dot larger than other points on the graph or has a color different from them for distinction. Thus, it is possible to see the screen and determine whether the current point P_{R} matches the in-focus point P₀ (x₀, yₘₐₓ) on the graph, therefore whether correct focusing has been achieved.

Furthermore, in plotting of the graph, the range of the Y-axis is automatically changed so that the Y coordinate value y corresponding to the maximum focus signal data item among all focus signal data items obtained since the start of graph plotting (start of the focus information display) has a predetermined maximum Y coordinate value yₘₐₓ. That is, given the maximum value F1 among all focus signal data items obtained, the range of the focus signal value that corresponds to the range of the Y coordinate value from the minimum value 0 to the maximum value (maximum Y coordinate value yₘₐₓ) is changed to the range from the minimum value 0 to the maximum value F1. The range of the focus signal value that corresponds to the range of the Y coordinate value 0 to the maximum Y coordinate value yₘₐₓ will be referred to as the Y-axis range hereafter. It is noted that although this embodiment defines the minimum Y coordinate value as a specific value 0, other values is also possible. In addition, although the Y-axis range is defined from the minimum value 0 to the maximum value F1 of the focus signal, any range may be used that includes the maximum value F1 and provides for a graph of an appropriate size.

For example, while the tracking lens is moved from the close focus end to the in-focus point, a graph that shows an upward tendency from the close focus end to the in-focus point as shown in FIG. 6 is plotted. In this situation, when the initial data of the focus signal and position signal (in this case, the data at the close focus end) is obtained from the lens 112, the focus signal value D(0) for the X coordinate value x that corresponds to the close focus end (=0) is the maximum value F1. The Y-axis range is then set to the range from the focus signal value 0 to the maximum focus signal value F1 (D(0)). Therefore, as shown in FIG. 7, the coordinates point P₁ (0, yₘₐₓ) is displayed as the current point. It is to be understood that where an X coordinate value for a given position signal value is represented as x, the focus signal value obtained for data of that position signal is represented as D(x) (x=0, 1, . . . , n).

Thereafter, new data of the focus signal and position signal is obtained while the tracking lens is moved. Each time new data is obtained, the maximum value F1 is changed to the new focus signal value D(x), and the Y-axis range is changed accordingly. Here, if the X coordinate value x for the latest position signal is N and the focus signal value is D(N), then the maximum value F1 becomes D(N), and a coordinates point P_{N} (N, yₘₐₓ) is displayed as the current point as shown in FIG. 7. Furthermore, the Y coordinate values y for the focus signal values D(x) (x=0 to N−1) obtained up to then are changed according to the Y-axis range, such that

y=yₘₐₓ·(D(x)/F1).

Then, coordinates points (x, y) that correspond to the X coordinate values x (x=0 to N−1) and the Y coordinate values y changed according to the above equation are plotted again as points that depict a graph. This results in a graph as a curve N in FIG. 7.

Thereafter, the current position moves while taking the maximum Y coordinate value yₘₐₓ until the tracking lens reaches the in-focus point P₀ (x₀, yₘₐₓ). When the in-focus point P₀ (x₀, yₘₐₓ) is reached, a graph is displayed (a dotted line M in FIG. 7) similar to the graph from the close-focus end to the in-focus point shown in FIG. 6.

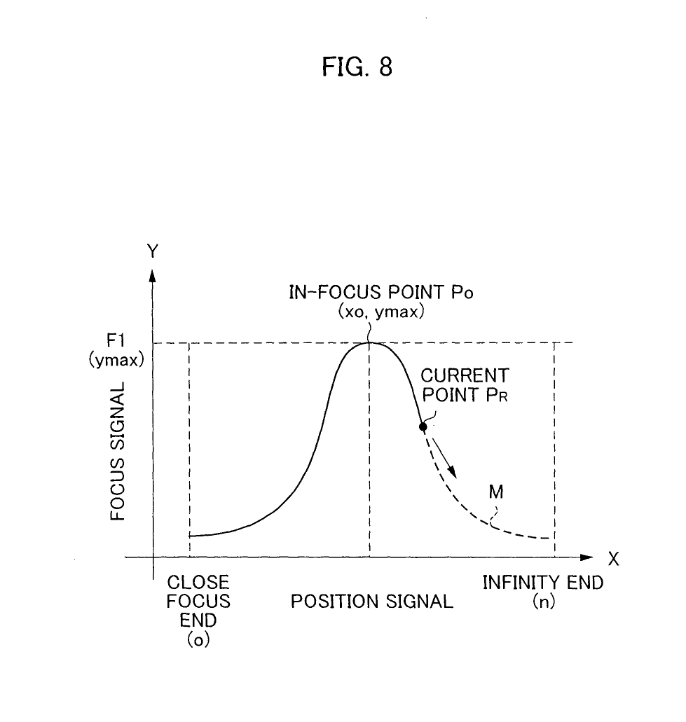

Then, while the tracking lens is moved from the in-focus point to the infinity end, a graph that shows a downward tendency from the in-focus point to the infinity end as shown in FIG. 6 is plotted. New data of the focus signal and position signal is obtained from the lens 112, but the value of the obtained focus signal D(x) no more exceeds the maximum value F1 (focus signal value at the in-focus point P₀), and therefore the Y-axis range does not change. Thus, as shown in FIG. 8, the Y coordinate value y at the current point P_{R} also decreases. Thereafter, while the tracking lens is moved to the infinity end, the current point P_{R} moves to leave a trace as indicated by a dotted line M in FIG. 8, and a graph similar to the graph shown in FIG. 6 from the in-focus point to the infinity end is displayed.

In actual tracking adjustment operation, it is not always necessary to move the tracking lens across the whole range from the close-focus end to the infinity end as described above. For example, the tracking lens may be started at any initial position in one direction. If the current Y coordinate value is observed as being below the maximum Y coordinate value yₘₐₓ, then the tracking lens is moved in the opposite direction. When the Y coordinate value of the current point becomes the maximum Y coordinate value yₘₐₓ, the tracking lens is fixed at that position. Thus, correct focusing is achieved. In some cases, the in-focus position may not be found in the initial moving direction of the tracking lens. Therefore, even if the current Y coordinate value is observed as being below the maximum Y coordinate value yₘₐₓ in the initial direction, the tracking lens is preferably moved in the opposite direction to confirm that the current Y coordinate value again becomes below the maximum Y coordinate value yₘₐₓ. Then, the position of the tracking lens is adjusted so that the current Y coordinate value becomes the maximum Y coordinate value yₘₐₓ.

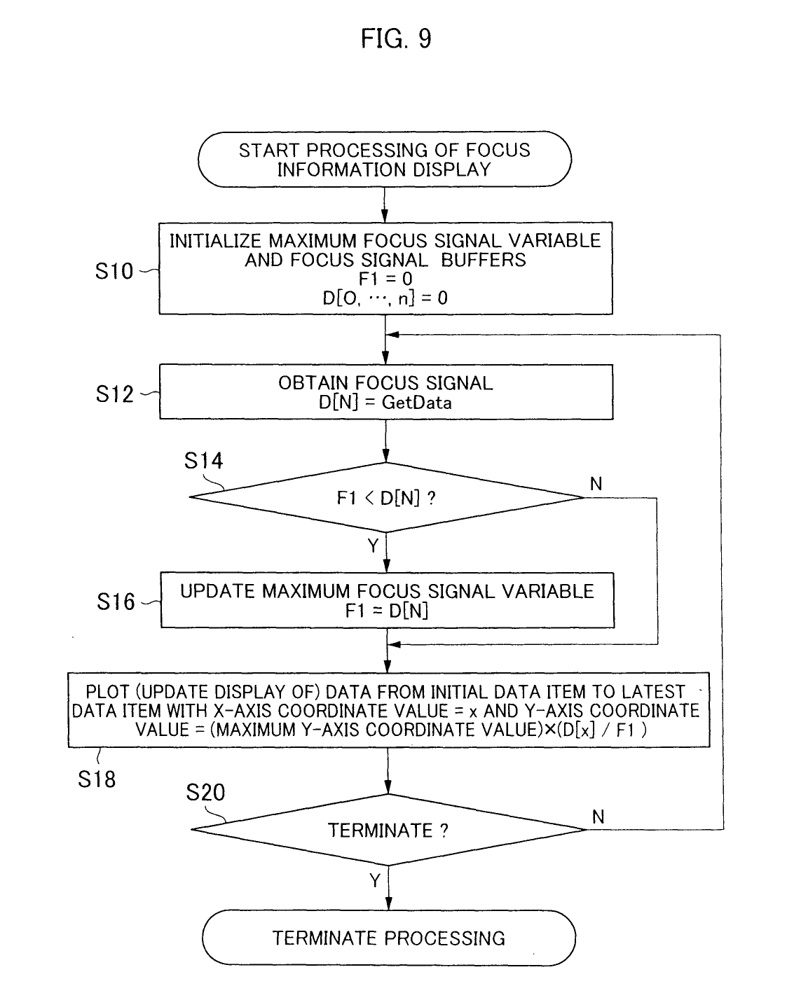

FIG. 9 is a flowchart showing processing steps in the personal computer 114 for displaying the focus information. Once the start of the focus information display (graph plotting) is instructed by operation of a device such as a keyboard, the CPU 130 first initializes the variable F1 that indicates the maximum focus signal value on the graph (maximum focus signal variable) and the focus signal buffers D(0), D(1), . . . , D(n) that store the focus signal value for each X coordinate value x (step S10), that is,

F1=0, and

D(x)=0 (x=0, 1, . . . , n).

Then, the CPU 130 obtains the focus signal data, as well as the position signal data of the tracking lens at that time from the CPU 124 of the lens 112. For an X coordinate value N that corresponds to the obtained position signal data, the focus signal value GetData obtained at that time is assigned to the focus signal buffer D(N) (step S12), that is,

D(N)=GetData.

The CPU 130 determines whether the value of the focus signal buffer D(N) obtained in step S12 is larger than the maximum focus signal variable F1 (step S14). If the determination is NO, it proceeds to step S18 without changing the maximum focus signal variable F1. If the determination is YES, it updates the maximum focus signal variable F1 to the value of the focus signal buffer D(N) (step S16), that is,

F1=D(N).

For the focus signal buffers D(x) for all X coordinate values x that have been obtained, the Y coordinate values y are set as

y=(maximum Y coordinate value yₘₐₓ)·(D(x)/F1).

Then, coordinates points (x, y) for all data items of the focus signal and position signal that have been obtained are plotted on the screen of the monitor 134 as points depicting a graph (step S18).

The CPU 130 then determines whether termination of the processing has been instructed by operation of a device such as the keyboard (step S20). If the determination is NO, it repeats the processing from step S12. If the determination is YES, it terminates the processing of this flowchart.

Thus, the Y-axis range is changed according to the maximum focus signal value, and the graph is displayed in an appropriate size irrespective of characteristics of the object such as the contrast. This enables determination of correct focusing and a focus adjustment with accuracy and ease.

In the above described graph display, the coordinates points for all data items obtained since the start of graph plotting are displayed on the screen. However, it is also possible to display coordinates points only for data items obtained within a predetermined period up to the latest data, or only for data items within a predetermined distance with respect to the X coordinate value at the current point.

Now, a second embodiment of the focus information display will be described. The above embodiment (a first embodiment) displays the relationship between the position signal and the focus signal on the monitor 134 of the personal computer 114 as a graph on which the x-axis indicates the position signal value of the tracking lens and the y-axis indicates the focus signal value. The second embodiment displays the relationship between time and the focus signal as a two-dimensional graph on which the x-axis indicates time and the y-axis indicates the focus signal value. Again, as in the first embodiment, the Y-axis range is automatically changed to be the range from the minimum value 0 to the maximum value F1 of the focus signal (the maximum value F1 is defined the same as in the first embodiment). Thus, a graph is displayed that facilitates determination of correct focusing irrespective of the magnitude of the focus signal.

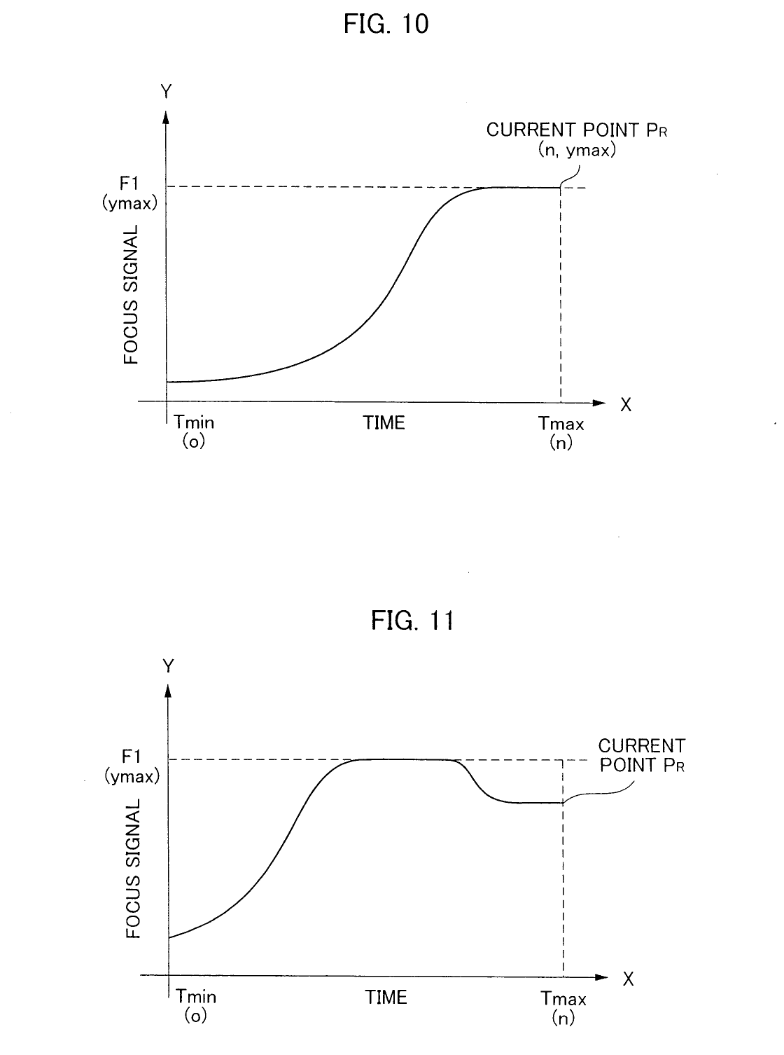

For example, in the second embodiment, the focus information is displayed as a graph on which the x-axis indicates time and the y-axis indicates the focus signal value on the monitor 134 of the personal computer 134, as shown in FIG. 10. The focus signal data is obtained periodically, and a time Tₘₐₓ is when the latest focus signal data item is obtained, whereas a time Tₘᵢₙ is when a data item that precedes the Tₘₐₓ by a predetermined amount of data (n items) is obtained. Then, the X-axis range is set so that the time range from the minimum X coordinate value 0 to the maximum X coordinate value n becomes the range from the time Tₘᵢₙ to the time Tₘₐₓ. That is, n+1 data items are obtained for the focus signal during the period from the time Tₘᵢₙ to the time Tₘₐₓ, and the X coordinate values for those data items are respectively assigned to integers 0 to n in order of occurrence. Therefore, when the CPU 130 of the personal computer 114 obtains new focus signal data, a coordinates point for the new focus signal data is plotted at a position where the X coordinate value takes the maximum value n. Every time a coordinates point for new focus signal data is plotted on the coordinates plane, coordinates points for the previous data that have been plotted on the coordinates plane are plotted to have their X coordinate value shifted by −1. Also, the coordinates point for data that has been displayed at a position where the X coordinate value is 0 is erased from the coordinates plane. On the screen, the graph is displayed as if it flows from the right to the left.

Furthermore, the maximum focus signal value among all focus signal data items obtained since the start of graph plotting is defined as F1. As in the first embodiment, the range of the focus signal value that corresponds to the range from the minimum Y coordinate value 0 to the maximum Y coordinate value yₘₐₓ is changed to the range from the minimum value 0 to the maximum value F1.

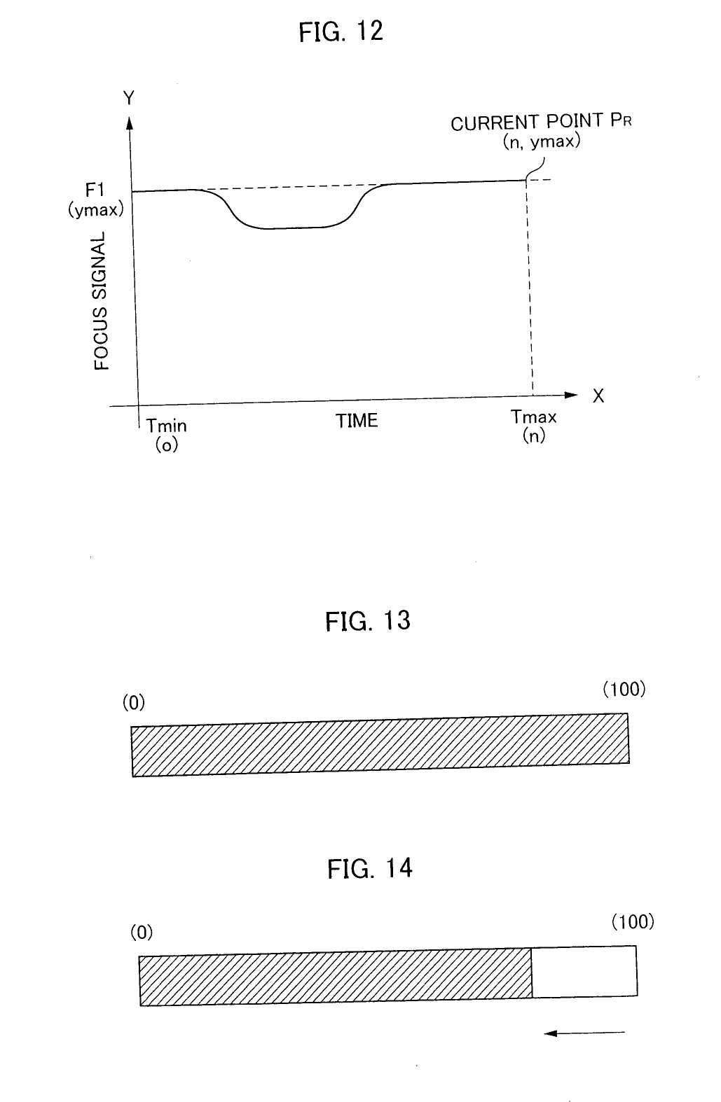

In actual movement of the tracking lens, as the tracking lens approaches to the in-focus position, the focus signal value increases and the maximum focus signal value F1 is continuously updated. Accordingly, the Y-axis range is changed. Thus, as shown in FIG. 10, a graph is displayed on which the Y coordinate value for the maximum X coordinate value xₘₐₓ takes the maximum coordinate value yₘₐₓ. Once the tracking lens passes through the in-focus position and the focus signal value begins to decrease, the maximum focus signal value F1 is fixed to the focus signal value at the in-focus position. The Y-axis range is also fixed to the range from 0 to the focus signal value at the in-focus position. Therefore, as shown in FIG. 11, the Y coordinate value for the maximum X coordinate value xₘₐₓ decreases. When this phenomenon is observed, the tracking lens is moved in the opposite direction to confirm that the Y coordinate value for the maximum X coordinate value n (coordinates point of the current point P_{R}) becomes the maximum Y coordinate value yₘₐₓ, as shown in FIG. 12. If this confirmation is obtained, it can be determined that correct focusing has been achieved.

When the Y-axis range is changed and the coordinates points are plotted to conform to new focus signal data, the coordinates points that have been plotted on the coordinates plane may alternatively have only their X coordinate value changed but maintain their Y coordinate value.

Now, a third embodiment of the focus information display will be described. In the above first and second embodiments, two-dimensional coordinates are rendered on the monitor 134 to display the focus information as a two-dimensional graph. In the third embodiment, the focus information is displayed as a one-dimensional graph, such as a bar graph as shown in FIG. 13 with its length corresponding to the focus signal value. By way of example, the size (length) of the bar graph on the screen is changed within the range from 0 to 100. Then, as in the first and second embodiments, the range of the focus signal value that corresponds to the size of the bar graph from 0 to 100 is defined as the range from 0 to the maximum focus signal value F1 (F1 is defined the same as in the first embodiment).

For example, when the tracking lens is moved toward an in-focus position, the focus signal value increases and the maximum focus signal value F1 is updated to the latest focus signal value. Therefore, as shown in FIG. 13, the bar graph is displayed in the maximum size (100). Once the tracking lens passes through the in-focus position and the focus signal value begins to decrease, the maximum focus signal value F1 is fixed to the focus signal value at the in-focus position. The range of the focus signal value, which corresponds to the range of the size of the bar graph from 0 to 100, is also fixed to the range from 0 to the focus signal value at the in-focus position. Therefore, as shown in FIG. 14, the size of the bar graph decreases. When this phenomenon is observed, the tracking lens is moved in the opposite direction to confirm that the size of the bar graph again reaches the maximum (100). If this confirmation is obtained, it can be determined that correct focusing has been achieved.

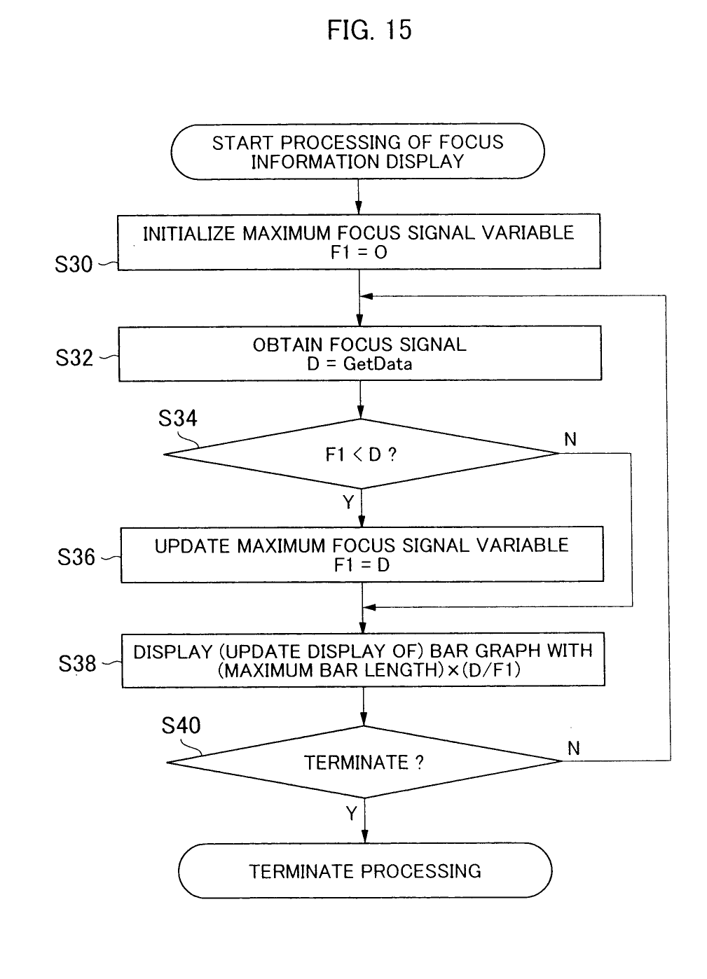

FIG. 15 is a flowchart showing processing steps in the CPU 130 of the personal computer 114 for displaying such a bar graph as the focus information. Once the start of the focus information display (graph plotting) is instructed by operation of a device such as a keyboard, the CPU 130 first initializes the variable F1 that indicates the maximum focus signal value (maximum focus signal variable), that is, F1=0 (step S30).

Then, the CPU 130 obtains the focus signal data from the CPU 124 of the lens 112. It assigns the focus signal value GetData obtained at that time to the focus signal buffer D, that is, D=GetData (step S32).

The CPU 130 determines whether the value of the focus signal buffer D obtained in step S32 is larger than the maximum focus signal variable F1 (step S34). If the determination is NO, it proceeds to step S38 without changing the maximum focus signal variable F1. If the determination is YES, it updates the maximum focus signal variable F1 to the value of the focus signal buffer D, that is, F1=D (step S36).

The CPU 130 then plots the bar graph in the size y (step S38), wherein the maximum value of the size of the bar graph is 100 and y=(maximum size 100)·(D/F1).

The CPU 130 then determines whether termination of the processing has been instructed by operation of a device such as the keyboard (step S40). If the determination is NO, it repeats the processing from step S32. If the determination is YES, it terminates the processing of this flowchart.

Thus, the bar graph is displayed with its size adjusted appropriately according to the maximum focus signal value. This enables determination of correct focusing and a focus adjustment with accuracy and ease.

In the third embodiment, numbers 0 to 100 (or other ranges of numbers) that represent the size of the bar graph may be displayed along with the bar graph. Alternatively, only these numbers may be displayed instead of the bar graph.

In the above embodiments, the focus information is displayed on the monitor 134 of the personal computer 114 connected to the lens 112. However, the focus information may be displayed on a personal computer connected to the camera 110 or on other display devices. For example, a display device other than the personal computer 114 may be connected to the camera 110 or lens 112 to allow data communication between them, and the focus information may be displayed on that display device. The focus information may also be displayed on a display device attached to the lens 112, a viewfinder of the camera 110, and so on. In particular, if it is displayed on a viewfinder of the camera 110, a simple display like the third embodiment is preferred so as not to interfere with a video display.

Although the maximum focus signal value F1 is determined every time the latest data item is obtained in the above embodiments, it may also be determined for each predetermined number of data items or at predetermined time intervals, for example.

The above embodiments have been described as using the focus information displayed on the display screen for adjusting a focus in the tracking adjustment. However, the focus information displayed may be used equally in normal shooting where a focus lens is moved for focusing.

Besides the graphs as in the above embodiments, display may take other forms of graph or numbers that enable recognition of the relative magnitude of the focus signal.

Furthermore, besides the graph display as described in the above embodiments, an indication or sound may be used to inform when determination is made that the current (latest) focus signal value is the maximum value F1 in order to facilitate determination of correct focusing.

Now, a description will be given of an embodiment in which a reset function is provided for resetting display data of the focus information in the television camera system. When a predetermined program is executed on the personal computer 114 for displaying the focus information, the condition of an object of shooting may change after the focus information begins to be displayed. For example, the object condition changes if the object is replaced with another object or the intensity of illumination changes after the focus information begins to be displayed. This situation tends to arise particularly if the focus information display as described in the above embodiments is applied to a normal focus adjustment (where a focus adjustment is performed by driving the focus lens). In such a case, the focus signal value at an in-focus position (the peak value of the focus signal) changes depending on the change in the object condition. Therefore, the focus signal value at the in-focus position after the object condition has changed may become smaller than that at the previous in-focus position. Then, in the focus information display, the focus signal values to be obtained under the new condition may not reach the maximum focus signal value (maximum focus signal variable) F1 that has been previously set. This causes a problem that the focus signal value at the in-focus position would not be displayed as the maximum value on the display screen of the focus information, which makes it difficult to identify the peak point of the focus signal.

A possible way to avoid this situation is to restart the program on the personal computer 114 if the object condition changes and to initialize the focus information display data (i.e., the value of the maximum focus signal variable F1) and the stored focus signal data (i.e., data in the focus signal buffers). However, completely terminating and then restarting the processing of the focus information display, like restarting the program, is problematic in that it takes time and effort. Therefore, this embodiment adopts a reset function that facilitates initialization of the focus information display data.

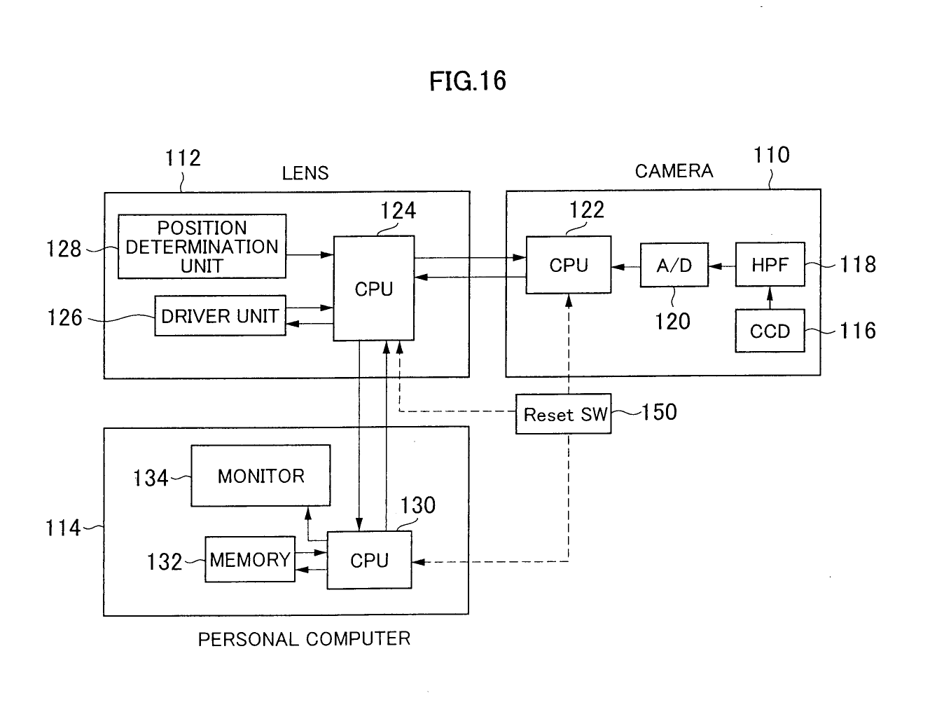

When the reset function is adopted, the television camera system shown in FIG. 5 is provided with a reset switch 150 as shown in FIG. 16. Description of components other than the switch 150 will be omitted, since they are just the same as those described for FIG. 5. The reset switch 150 may be placed on any of the camera 110, lens 112, and personal computer 114, and its on/off operation may be read by any of the CPU 122 of the camera 110, CPU 124 of the lens 112, and CPU 130 of the personal computer 114. If the on/off operation of the reset switch 150 is read by the CPU 122 of the camera 11 or the CPU 124 of the lens 112, the read information is transmitted to the CPU 130 of the personal computer 114 (or to a CPU other than that of the personal computer 114, if that other CPU is to process the focus information display).

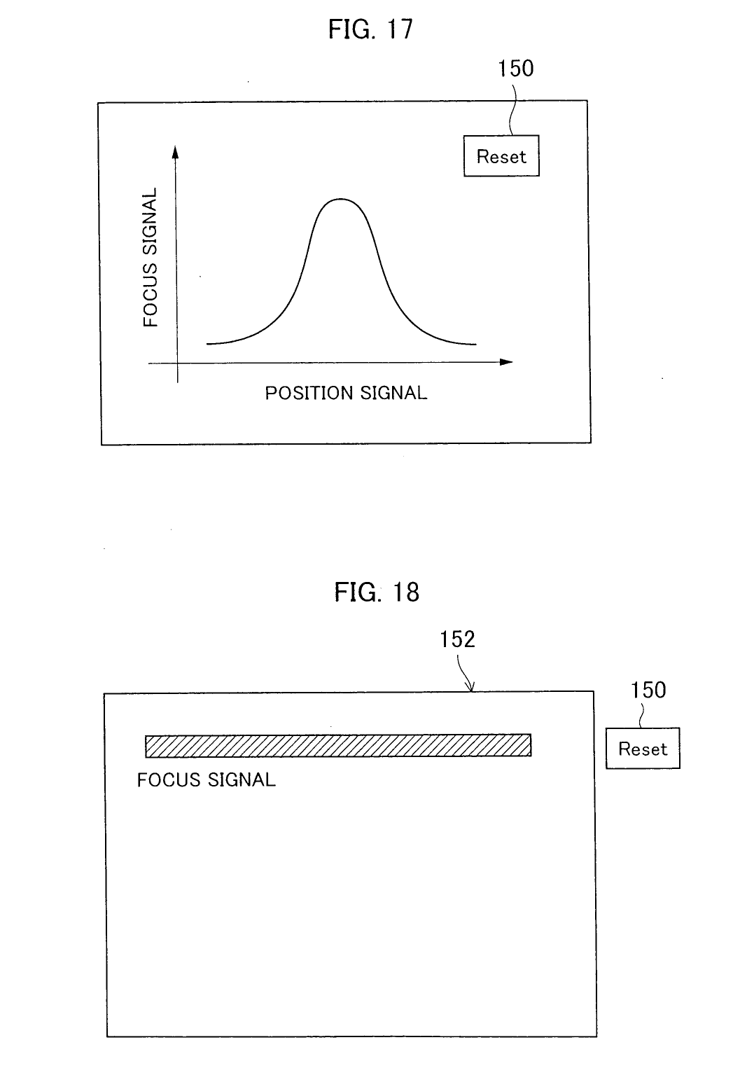

The reset switch 150 may be configured in any manner that enables recognition that an operator has instructed a reset. For example, the reset switch 150 placed on the personal computer 114 may be a certain key on the keyboard, rather than a dedicated component. Alternatively, as shown in FIG. 17, the reset switch 150 may be displayed on the screen of the monitor 134 that displays the focus information and may be turned on/off by a mouse click. If the monitor 134 is a touch panel monitor, the displayed reset switch 150 may be operated with a touch of a finger.

The focus information display as described in the above first to third embodiments may be displayed on a viewfinder of the camera 110. Then, as shown in FIG. 18, the reset switch 150 may be placed at a frame portion around a viewfinder screen 152 that displays the focus information as a graph such as the bar graph described in the third embodiment.

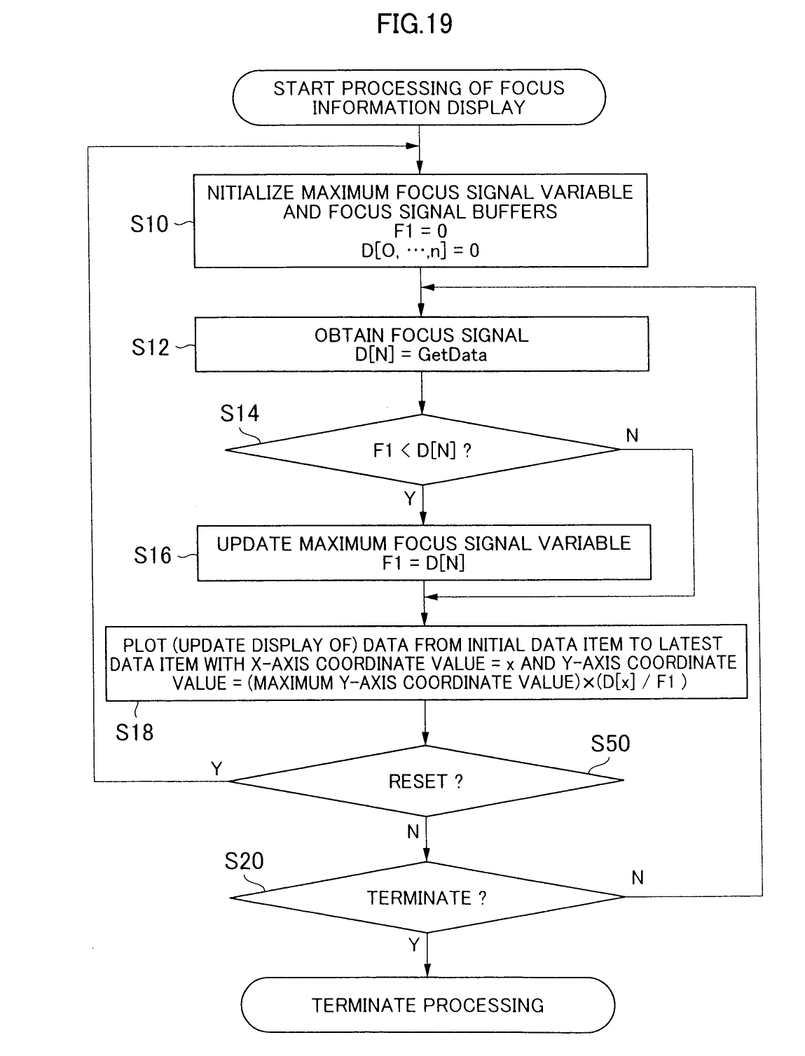

Now, FIG. 19 shows a flowchart of processing steps in the CPU 130 of the personal computer 114 where the processing of the reset function is enabled in the focus information display mode described in the first embodiment (see FIGS. 6 to 8). In the flowchart of FIG. 19, processing blocks with the same step numerals as those in the flowchart of FIG. 9 that shows the processing steps of the first embodiment represent the same processing as in the FIG. 9 and will not be described again. Thus, a determination processing of step S50 has been added in FIG. 19. In step S50, it is determined whether a reset has been instructed by turning on the reset switch 150. If the determination is NO, the process proceeds to processing of the next step S20. If the determination is YES, the process returns to the processing of the step S10, where the variable F1 that indicates the maximum focus signal value (maximum focus signal variable) is initialized, and the focus signal buffers D(0), D(1), . . . , D(n) that store a focus signal value for each X coordinate value x are initialized. Thus, turning on the reset switch 150 causes initialization of the display data used for the focus information display. The graph on the screen may also be initialized in the processing of step S10. Also, when the reset is instructed by the reset switch, only the maximum focus signal variable F1 may be initialized but not the focus signal buffers D(0), D(1), . . . , D(n), so that the focus signal data before resetting may remain displayed on the graph.

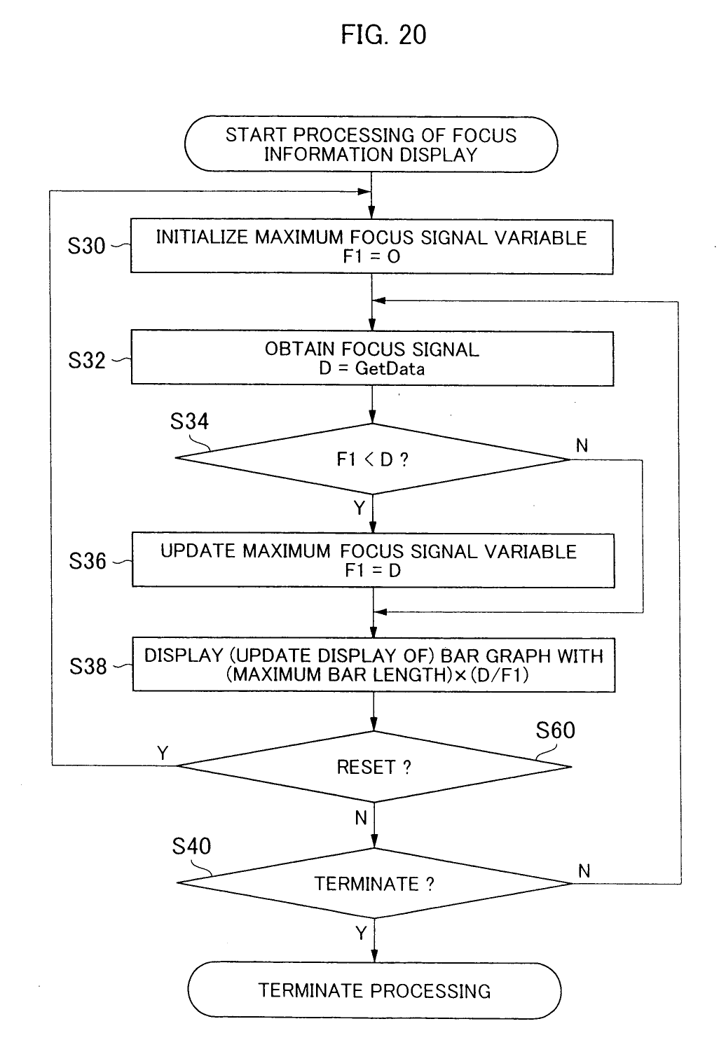

Next, FIG. 20 shows a flowchart of processing steps in the CPU 130 of the personal computer 114 where the processing of the reset function (reset processing) is enabled in the focus information display mode described in the third embodiment (see FIGS. 13 and 14). In the flowchart of FIG. 20, processing blocks with the same step numerals as those in the flowchart of FIG. 15 that shows the processing steps of the third embodiment represent the same processing as in the FIG. 15 and will not be described again. Thus, a determination processing of step S60 has been added in FIG. 20. In step S60, it is determined whether a reset has been instructed by turning on the reset switch 150. If the determination is NO, the process proceeds to processing of the next step S40. If the determination is YES, the process returns to the processing of the step S30, where the variable F1 that indicates the maximum focus signal value (maximum focus signal variable) is initialized. Thus, turning on the reset switch 150 causes initialization of the display data used for the focus information display. The bar graph on the screen may also be initialized in the processing of step S30.

This reset function is not limited to the focus information display mode described in the first and third embodiments, but may also be applied to other focus information display modes.

Now, a description will be given of an embodiment in which a best focus indication function is provided for indicating the best focus (in-focus) in the focus information display in the television camera system. By way of example, this embodiment will be described for the focus information display mode in the third embodiment (bar graph display; see FIGS. 13 and 14). Until the tracking lens passes through an in-focus position (the peak point of the focus signal), the bar graph is displayed in the maximum size while the focus signal value increases. Once the in-focus position is passed through, the bar graph is ideally no more displayed in the maximum size except at the in-focus position. Here, determining whether the bar graph is in the maximum size requires some attention. Therefore, to facilitate the determination whether the best focus has been achieved, this embodiment adopts the best focus indication function for indicating whether the current focus signal value is the real maximum value that indicates correct focusing, that is, whether the tracking lens is currently at the in-focus position. This embodiment will be described for the case where the reset function is also provided.

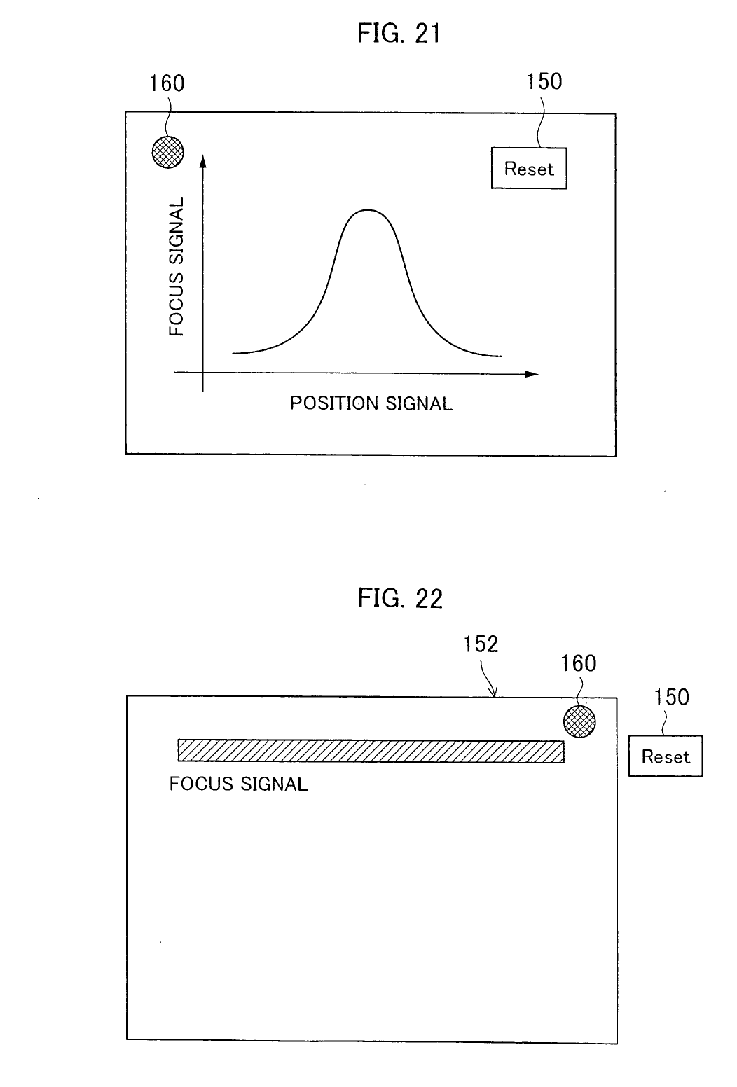

FIG. 21 shows a screen of the monitor 134 of the personal computer 114. This screen displays a best focus indication mark 160 for informing whether the best focus has been achieved (informing the best focus), along with the focus information described in the first embodiment. For example, if determination is made that the current focus signal value obtained from the camera 110 is the in-focus value (real maximum value), the best focus indication mark 160 is displayed; otherwise the best focus indication mark 160 disappears. Alternatively, the best focus indication mark 160 may always reside on the display, and the determination of the best focus may be made according to a change in its color, brightness, luminance, and so on. In the figure, the reset switch 150 described in FIG. 17 is also displayed.

FIG. 22 shows the viewfinder screen 152 that displays the focus information as the bar graph described in the third embodiment, as well as the best focus indication mark 160 similar to that of FIG. 21. Description of FIG. 22 will be omitted. In FIG. 22, the reset switch 150 described in FIG. 18 is also displayed.

The display of the best focus may be accomplished by a lamp such as a LED, which is provided at a desired position, and any other means, rather than on the image of the monitor 134 of the personal computer 114 or on the image of the viewfinder.

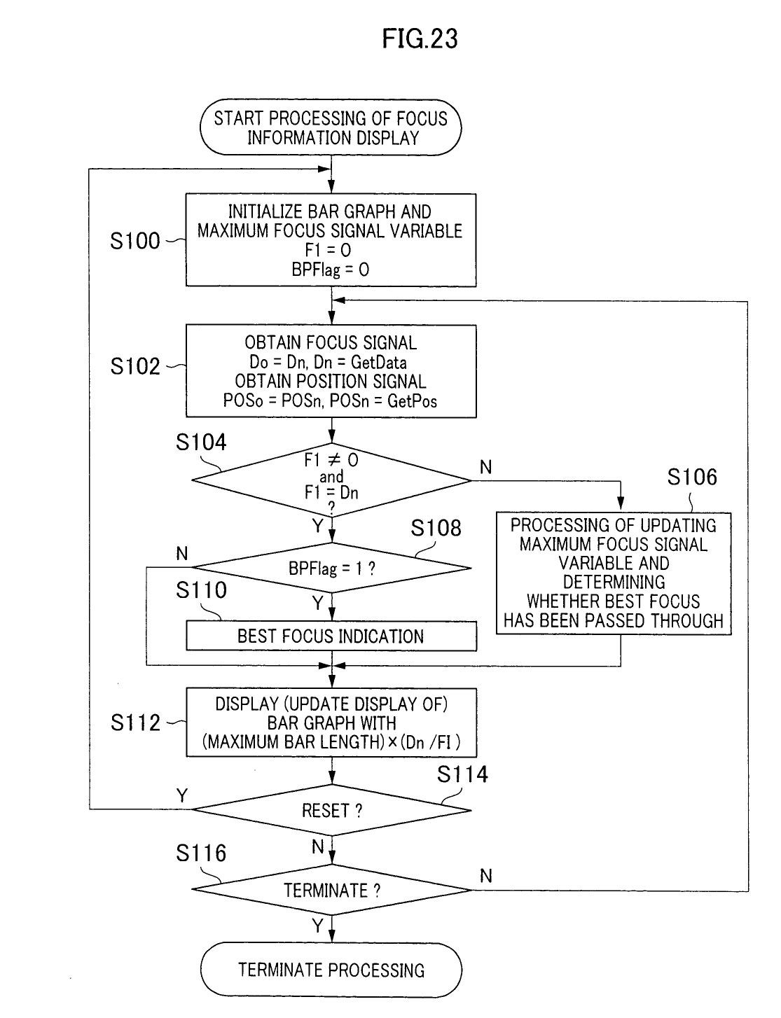

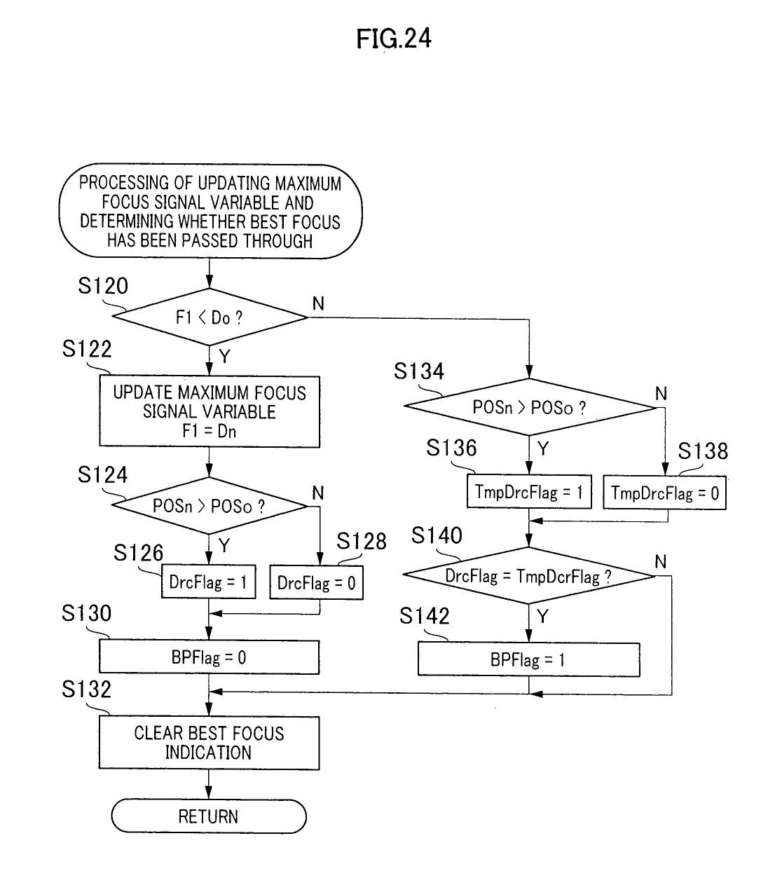

Now, with reference to flowcharts of FIGS. 23 and 24, description will be given of processing steps in the CPU 130 of the personal computer 114 where the processing of the best focus function is enabled in the focus information display mode described in the third embodiment (see FIGS. 13 and 14).

Once the start of the focus information display (graph plotting) is instructed by operation of a device such as a keyboard, the CPU 130 of the personal computer 114 first initializes the bar graph, as well as the variable F1 that indicates the maximum focus signal value (maximum focus signal variable) and a predetermined flag BPFlag, that is, F1=0 and BPFlag=0 (step S100). The flag BPFlag, which indicates whether the tracking lens (or the focus lens) has passed through the best focus position, is set to 1 if it has passed through the best focus position and to 0 otherwise.

The CPU 130 then obtains the focus signal data, as well as the position signal data for the tracking lens at that time from the CPU 124 of the lens 112. It assigns the value of a focus signal buffer Dn to a focus signal buffer Do, and assigns the focus signal value GetData obtained at that time to the focus signal buffer Dn, that is, Do=Dn and Dn=GetData. It also assigns the value of a position signal buffer POSn to a position signal buffer POSo, and assigns the position signal value GetPos obtained at that time to the position signal buffer POSn (step S102). It is to be understood that the focus signal buffer Dn and the position signal buffer POSn are assigned the latest focus signal value and position signal value respectively, and the focus signal buffer Do and the position signal buffer POSo are assigned the previously obtained focus signal value and position signal value respectively.

The CPU 130 then determines whether the maximum focus signal variable F1 is not 0 and the value of the focus signal buffer Dn obtained in step S102 is equal to the maximum focus signal variable F1 (step S104). This results in NO whenever the determination is made for the first time after the processing of step S100. If the determination is NO in this processing, step S106 is performed as will be described later. The processing in step S106 includes updating the maximum focus signal variable F1 and determining whether the best focus has been passed through. After this processing, the process returns to step S112.

If the determination is YES in step S104, then the CPU 130 determines whether the flag BPFlag=1 (step S108). That is, because the BPFlag has been set to 1 in step S106 if the tracking lens has passed through the best focus position, it is determined whether the tracking lens has passed through the best focus position in the processing of step S108. If the determination in step S108 is YES, it also means that the maximum focus signal variable F1 has been set to the best focus value. Also, the determination in step S104 has confirmed that the latest focus signal value Dn is equal to the maximum focus value variable F1. This shows that the tracking lens is currently at the best focus position. Therefore, if the determination in step S108 is YES, the best focus indication is executed (step S110). For example, the best focus indication mark 160 as shown in FIGS. 21 and 22 is displayed on the screen.

The CPU 130 then plots (updates the display of) the bar graph as shown in FIGS. 13 and 14 in the size y (step S112), wherein the maximum value of the size of the bar graph is 100 and y=(maximum size 100)·(Dn/F1).

The CPU 130 then determines whether a reset has been instructed by turning on the reset switch 150 (step S114). If the determination is YES, it returns to the step S100 and restarts with the initialization. If the determination is NO, it determines whether termination of the processing has been instructed by operation of a device such as the keyboard (step S116). If the determination is NO, it repeats the processing from step S102. If the determination is YES, it terminates the processing of this flowchart.

Now, the processing in step S106 will be described with reference to a flowchart of FIG. 24. If the determination is NO in step S104, then the CPU 130 determines whether the value of the focus signal buffer Dn obtained in step S102 is larger than the maximum focus signal variable F1 (step S120). If the determination is YES, it updates the maximum focus signal variable F1 to the value of the focus signal buffer Dn, that is, F1=Dn (step S122).

The CPU 130 then determines whether the value of the position signal buffer POSn obtained in step S102 is larger than the position signal buffer POSo (step S124). That is, it determines the moving direction of the tracking lens. It sets a flag DrcFlag to 1 if the determination is YES (step S126), or to 0 if the determination is NO (step S128). It then sets the flag BPFlag to 0 (step S130). The BPFlag is set to 0 because the determination YES in step S120 means that the focus signal value is increasing and therefore it cannot be determined that the tracking lens has passed through the best focus position (the peak of the focus signal). The flag DrcFlag, which indicates the moving direction of the tracking lens, is used for storing the moving direction of the tracking lens at the time when the determination in step S120 is YES, that is, when the increase in the focus signal value is determined.

After the processing in step S130, the CPU 130 clears the best focus indication (step S132). For example, it erases the best focus indication mark 160 shown in FIGS. 21 and 22 from the screen. It then proceeds to the step S112 in FIG. 23.

If the determination is NO in the step S120, the CPU 130 determines whether the value of the position signal buffer POSn obtained in step S102 is larger than the position signal buffer POSo (step S134). That is, it determines the moving direction of the tracking lens. It sets a flag TmpDrcFlag to 1 if the determination is YES (step S136), or to 0 if the determination is NO (step S138).

The CPU 130 then determines whether the value of the flag DrcFlag set in step S126 or S128 and the value of the flag TmpDrcFlag set in step S136 or S138 are equal (step S140). That is, it determines whether the moving direction of the tracking lens when the increase of the focus signal has been determined just before the focus signal value begins to decrease is the same as that when the decrease of the focus signal value has been determined. If the determination is YES, it means that the increase and decrease of the focus signal has been determined for the same moving direction of the tracking lens. Therefore, it can be determined that the tracking lens has passed through the best focus position, and the flag BPFlag is set to 1. If the determination is NO, the flag BPFlag is not changed. The CPU 130 then clears the best focus indication (step S132) and proceeds to step S112 in FIG. 23.

The best focus indication function is not limited to the focus information display mode described in the third embodiments, but may also be applied to other focus information display modes.

As described above, with the camera system according to the present invention, the focus evaluation value used for autofocus (AF) and the focus position at the time of determination of the focus evaluation value can be outputted to a peripheral device. This enables an operator to readily obtain information on the focus evaluation value from the peripheral device in a case such as an AF malfunction and thereby referring to the information to elucidate the cause of the AF malfunction.

Furthermore, with the focus information display apparatus according to the present invention, the relative magnitude of the focus signal continuously obtained is displayed as a magnitude recognizable with a graph or number on a display screen. The size of the graph or number is changed according to the focus signal value so that the size of the graph or number that corresponds to the maximum focus signal value obtained becomes a predetermined size. Therefore, the magnitude of the focus signal can be displayed on the display screen with an appropriate size of graph or number irrespective of variances of the magnitude of the focus signal due to different objects of shooting. This enables determination of correct focusing and a focus adjustment with accuracy and ease. Furthermore, since the maximum focus signal value obtained can be reset, the magnitude of the focus signal can be displayed with an appropriate size of graph or number by a reset instruction even if the condition of an object has changed. In addition, an in-focus indication device is provided for indicating whether the focus position of a shooting lens is an in-focus position, which also enables determination of correct focusing and a focus adjustment with accuracy and ease.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A camera system, comprising:
a focus evaluation value determination device which determines a focus evaluation value corresponding to a contrast of an object image shot by a shooting lens;
an autofocus device which automatically adjusts a focus of the shooting lens for an in-focus state according to the focus evaluation value determined by the focus evaluation value determination device; and
an output device which outputs, to a peripheral device, the focus evaluation value determined by the focus evaluation value determination device and a focus position of the shooting lens at the time of determination of the focus evaluation value.

2. The camera system as defined in claim 1, wherein the output device transmits the focus evaluation value and the focus position by serial communication to the peripheral device connected to allow serial communication.

3. The camera system as defined in claim 1, wherein the peripheral device obtains the focus evaluation value and the focus position outputted from the output device and comprises a display device for displaying a relationship between the focus evaluation value and the focus position as a graph.

4. The camera system as defined in claim 1, wherein the peripheral device is a personal computer.

5. A focus information display apparatus which generates a focus signal representing a degree of focusing according to a high-frequency component of an image formed by a shooting lens and displays focus information on a display screen according to the generated focus signal, the apparatus comprising:
a focus signal obtaining device which continuously obtains the focus signal while a focus position of the shooting lens is changed;
a maximum value determination device which determines a maximum value of the focus signal obtained by the focus signal obtaining device;
a display device which displays a relative magnitude of the focus signal obtained by the focus signal obtaining device as a magnitude recognizable with at least one of a graph and a number on the display screen; and
a changing device which changes a size of the displayed at least one of graph and number according to a value of the focus signal obtained by the focus signal obtaining device so that the size of the displayed at least one of graph and number on the display screen that corresponds to the maximum value determined by the maximum value determination device becomes a predetermined size irrespective of how large the maximum value is.

6. The focus information display apparatus as defined in claim 5, wherein:
the display device displays a graph on which coordinate values of a coordinate axis on the display screen correspond to values of the focus signal obtained by the focus signal obtaining device; and
the changing device changes a range of the values of the focus signal that corresponds to a range of the coordinate axis from a minimum coordinate value to a maximum coordinate value into a range of the focus signal from a minimum value to the maximum value obtained by the maximum value determination device.

7. The focus information display apparatus as defined in claim 5, wherein the maximum value determination device determines the maximum value of the focus signal each time the focus signal is obtained by the focus signal obtaining device.

8. The focus information display apparatus as defined in claim 5, further comprising:
a reset instruction device which instructs a reset,
wherein once a reset is instructed by the reset instruction device, the maximum value determination device determines the maximum value among values of the focus signal obtained by the focus signal obtaining device after the instruction.

9. The focus information display apparatus as defined in claim 5, further comprising an in-focus indication device which indicates whether a current focus position of the shooting lens is an in-focus position according to the focus signal obtained by the focus signal obtaining device.
